(19) United States
(12) Patent Application Publication
(10) Pub. No.: US 2015/0262247 A1
(43) Pub. Date: Sep. 17, 2015

(54) CURBSIDE CART DIRECT MARKETING SYSTEMS AND METHODS

(71) Applicant: National Cart Marketing, LLC, New Buffalo, MI (US)

(72) Inventors: Philip H. Bonello, New Buffalo, MI (US); David Workman, New Buffalo, MI (US); John Guenther, Chicago, IL (US)

(73) Assignee: National Cart Marketing, LLC

(21) Appl. No.: 14/644,715

(22) Filed: Mar. 11, 2015

Related U.S. Application Data
(60) Provisional application No. 61/950,907, filed on Mar. 11, 2014.

(51) Int. Cl. G06Q 30/02

(52) U.S. Cl. CPC G06Q 30/0269

(57) ABSTRACT

A marketing system including an ad receiving item including a first ad receiving space associated with a unique identifier, a database including a plurality of unique identifiers each associated with an address and a demographic trait information, a controller, and a memory including instructions that cause the controller to receive a plurality of ads, populate the first ad receiving space with a first selected ad associated with targeting information that matches the demographic trait information of the first ad receiving space, upon user interaction with the call-to-action token of the first selected ad, receive user interaction information including user demographic information, update the demographic trait information associated with the unique identifier to include the user demographic information, and populate a second ad receiving space with a second selected ad from the plurality of ads, wherein the second selected ad is associated with targeting information that matches the user demographic information.

### CROSS-REFERENCE TO RELATED APPLICATIONS

This application incorporates by reference and claims the benefit of priority to U.S. Provisional Patent Application No. 61/950,907 filed Mar. 11, 2014.

### BACKGROUND OF THE INVENTION

The present subject matter relates generally to a systems and methods for cooperative direct marketing using curbside carts. More specifically, the present invention relates to systems and methods to provide marketers new channels to target consumers and measure their response to the advertising by using curbside carts with tailored calls-to-action.

Trash carts are often owned by cities that provide the carts near consumer residences and businesses to provide trash related services, such as pickup, recycling, etc. Due to their proximity to the residences and daily use, trash carts are one of the most frequently used and most frequently encountered services provided by municipalities. However, unlike other municipal services, for example, buses, there has been poor utilization of trash carts for the provisioning of advertising and city services. There are numerous opportunities to capitalize on this under-utilization given an appropriate platform. Thus, there is a need to provide mechanisms through which access to the consumer provided by trash carts may be monetized.

Accordingly, there is a need for systems and methods for cooperative direct marketing using curbside carts, as described herein.

### BRIEF SUMMARY OF THE INVENTION

To meet the needs described above and others, the present disclosure provides systems and methods for cooperative direct marketing using curbside carts. The direct marketing systems and methods of the present disclosure may be used with carts adapted to receive advertising materials, for example, the direct marketing system may be used with carts including trash cart smart lids as described in U.S. Published Application No. 2014/0367292 the entirety of which is hereby incorporated by reference. Although described herein as used with curbside trash and recycling carts, it is it contemplated that the present disclosure may be used with other objects that may receive advertising, and that the present disclosure is not meant to be limited only to carts.

In general, a single advertising message or single cart sponsor will not generate sufficient income to support a viable advertising business model. By providing a cooperative direct marketing system using curbside carts, the present disclosure provides for a viable business model wherein a single cart includes advertising from a plurality of advertisers in different product categories.

Carts are used in extremely abusive environments and subjected to violent concussions, abrasions, contact with heavy equipment and exposure to a wide temperature range and an extended UVC. Consequently permanent messaging for organizations other than for haulers, manufacturers or municipalities is not a viable idea. Increasing the number of advertising messages and making the advertising messages impermanent solves these problems.

Additionally, by providing a direct marketing system that includes capturing consumer response data, the system and advertisers may measure the response to advertising campaigns. The response data may be used to improve the effectiveness of future advertising, improve the targeting of consumers, improving the efficiency of advertising pricing, etc.

The direct marketing system permits advertisers to purchase advertising targeting desired consumers. Ads from various advertisers may be selected to populate advertising spaces or “slots”. Each lid may contain a number of spaces, and each space may be available for a defined time period and for a number of homes. Once the ads for a cart are selected, the graphics for the ads may be printed on a UV resistant material, such as UV resistant polystyrene, using UV resistant ink. Printed cards may be trimmed to fit snugly in J-channels.

Each ad may include a call-to-action to elicit a trackable response from a consumer. The call-to-action may include a token, such as a URL, QR code, coupon, telephone number, augment reality beacon, etc., that may be used by the consumer to interact with a desired website, telephone, retail location, augmented reality system, etc., (herein, the consumer is generically described as responding by interacting with an “interaction point”). For example, the consumer may visit a website interaction point using a URL from a call-to-action and make a purchase. The website may record details of the response, such as the purchase amount, and transmit the details back to system. In an embodiment, the interaction point is a part of, or is provided by, the system. For example, the website interaction point may be provided by the controller. In other embodiments, the interaction point may be a third-party system in communication with the controller.

The system may record the response details in a response history. The response history may be used to improve targeting of consumers with future advertising and to derive response metrics to permit advertisers to measure the effectiveness of advertising, determine appropriate advertising pricing, etc.

In an embodiment, a marketing system includes: a network interface; an ad receiving item including a first ad receiving space, wherein the receiving item is associated with a unique identifier; a database including a plurality of unique identifiers, wherein each unique identifier is associated with an address and a demographic trait information; a controller in communication with the network interface and the database; and a memory in communication with the controller, the memory including instructions, that when executed by the controller, cause the controller to: a) receive a plurality of ads from an advertiser via the network interface, wherein each received ad is associated with a targeting information, b) populate the first ad receiving space with a first selected ad from the plurality of ads, wherein the first selected ad is associated with targeting information that matches the demographic trait information associated with the unique identifier of the first ad receiving space, wherein the first selected ad includes a call-to-action token; c) upon user interaction with the call-to-action token, receive user interaction information, wherein the user interaction information includes a user demographic information associated with the user; d) update the demographic trait information associated with the unique identifier in the database to include the user demographic information; and e) populate a second ad receiving space with a second selected ad from the plurality of ads, wherein the second selected ad is associated with targeting information that matches the user demographic information associated with the unique identifier of the second ad receiving space.

In some embodiments, each ad receiving item is configured to receive a plurality of selected ads. And, in some embodiments, the ad receiving item is a cart lid.

In some embodiments, the demographic trait information includes a demographic trait of a person other than those living at the address. Similarly, in some embodiments, the demographic trait information includes a demographic trait of a person who previously made a purchase using a call-to-action token associated with the unique identifier. Likewise, in some embodiments, the demographic trait information includes a demographic trait of a person living at addresses in proximity to the address. Further, in some embodiments, the demographic trait information includes a product category of a purchase, wherein the second selected ad is associated with a product, wherein the product is associated with product category.

In some embodiments, each ad receiving item includes a plurality ad receiving spaces, wherein the controller is configured to populate each of the plurality of ad receiving spaces with a plurality of selected ads, wherein each call-to-action token associated with each selected ad is different.

In some embodiments, the user interaction includes a purchase by the user. And, in some embodiments, the user interaction includes a coupon use by the user. Additionally, in some embodiments, the user interaction includes a phone call by the user.

In some embodiments, the call-to-action token is a URL. And in some embodiments, the call-to-action token is a telephone number. Additionally, in some embodiments, the call-to-action token is a coupon code. Further, in some embodiments, the call-to-action token is an augmented reality beacon. Also, in some embodiments, the memory includes further instructions to: derive a response metric from the user interaction information of the interaction.

In an embodiment, a method for marketing, includes the steps of providing a cart, wherein the cart includes an ad receiving space, wherein the ad receiving space is associated with a unique identifier, wherein each unique identifier is associated with an address and a demographic trait information; receiving a plurality of ads from an advertiser, wherein each received ad is associated with a targeting information, selecting a selected ad from the plurality of ads, wherein the selected ad is associated with targeting information that matches the demographic trait information associated with the unique identifier of the cart; printing the selected ad to form an advertising placard; installing the advertising placard in the ad receiving space of the cart; upon user interaction with a call-to-action token associated with the selected ad, receiving user interaction information, wherein the user interaction information includes a user demographic information associated with the user; updating the demographic trait information associated with the unique identifier in the database to include the user demographic information; selecting a second selected ad from the plurality of ads, wherein the selected ad is associated with targeting information that matches the demographic trait information associated with the unique identifier of the cart; printing the second selected ad to form an advertising placard; and installing the second advertising placard in the ad receiving space of the cart.

An advantage of the invention is that it provides a system for cooperative marketing on curbside carts to permit advertisers to share the cost of advertising.

Another advantage of the invention is that it provides a system for measuring the response to advertising to permit improved targeting, improved marketing, and an improved response from consumers.

A further advantage of the invention is that it provides a system that monetizes existing eyeballs in a cost-effective manner.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a diagram illustrating an example of a direct marketing system.

FIG. 2A is a perspective view of an example cart lid including advertising spaces.

FIG. 2B is a perspective view of another example cart lid including advertising spaces.

FIG. 3A is an example of an advertising placard including ads.

FIG. 3B is another example of an advertising placard including ads.

FIG. 4 is a diagram illustrating a profile for a cart.

FIG. 5 is a flow chart illustrating a method for direct marketing using the direct marketing system.

### DETAILED DESCRIPTION OF THE INVENTION

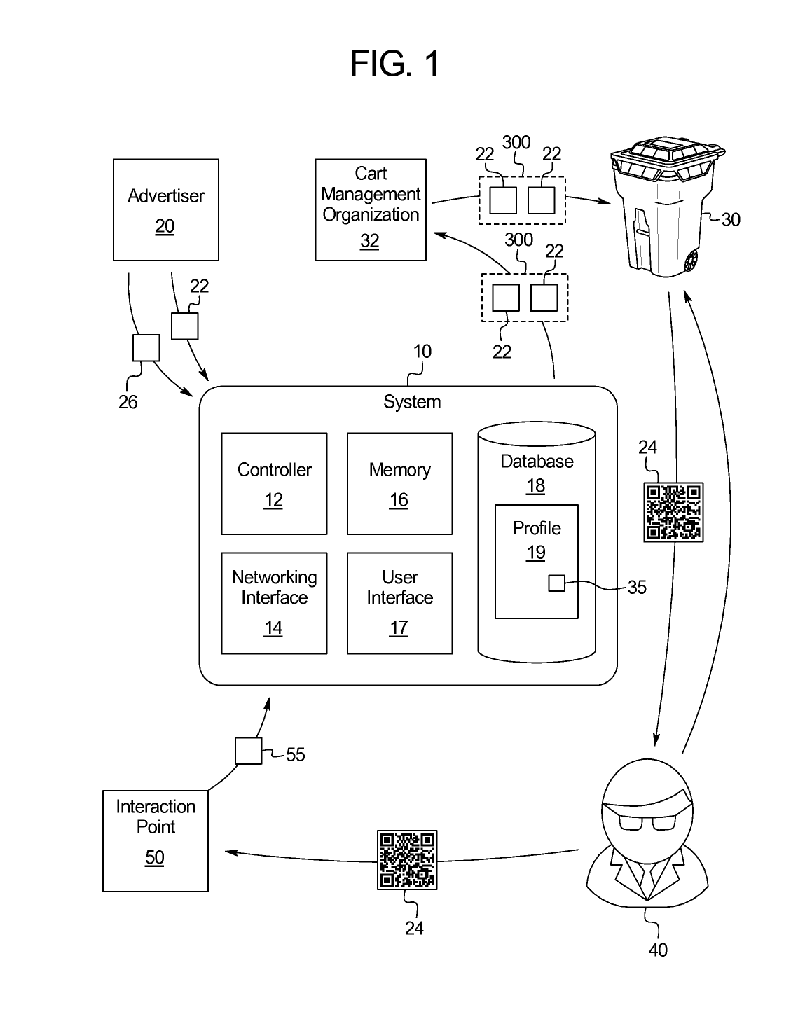

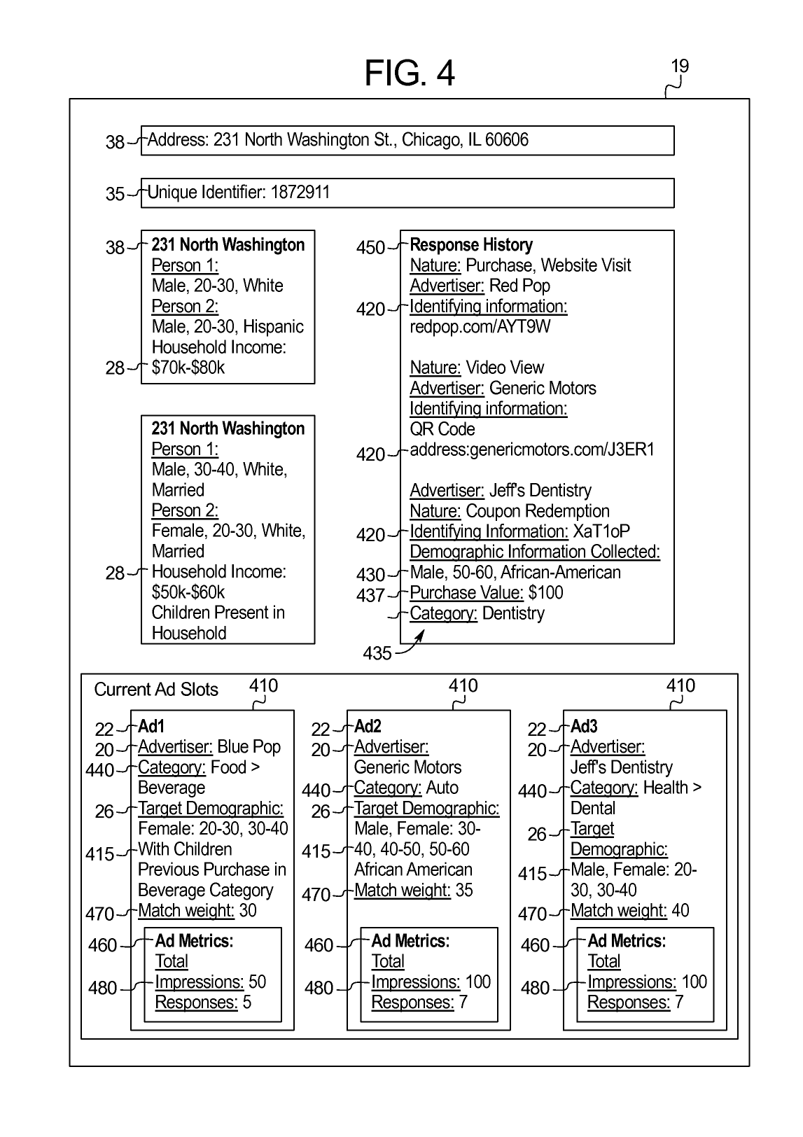

FIG. 1 illustrates an example of a direct marketing system 10. As shown in FIG. 1, advertisers 20 may provide advertising 22 (hereinafter an ad 22) to the direct marketing system 10. An ad 22 may be associated with target demographic trait information 415 (FIG. 4) including target 28 describing targeted consumers 40. The direct marketing system 10 may then select ads 22 to display on available curbside carts 30 (such as trash and recycling carts 30) by comparing the targeting information 26 with profiles 19 for the cart 30. The profiles 19 may include demographic trait information 28 describing consumers 40 that live nearby the cart 30. Each cart 30 may be identified within the direct marketing system 10 by a unique identifier 35 to permit the direct marketing system 10 to assign the ads 22 to specific carts 30. Once selected, the system 10 may assemble the ads 22 into advertising placards 300 for distribution to cart management organizations 32.

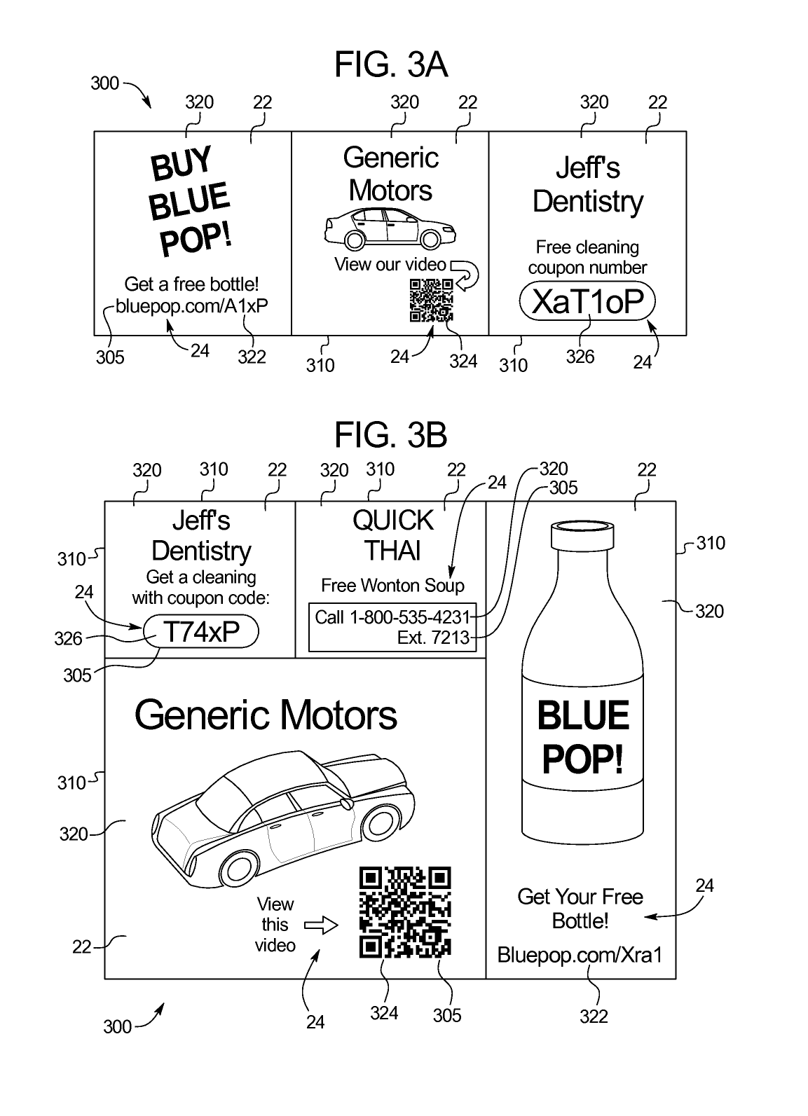

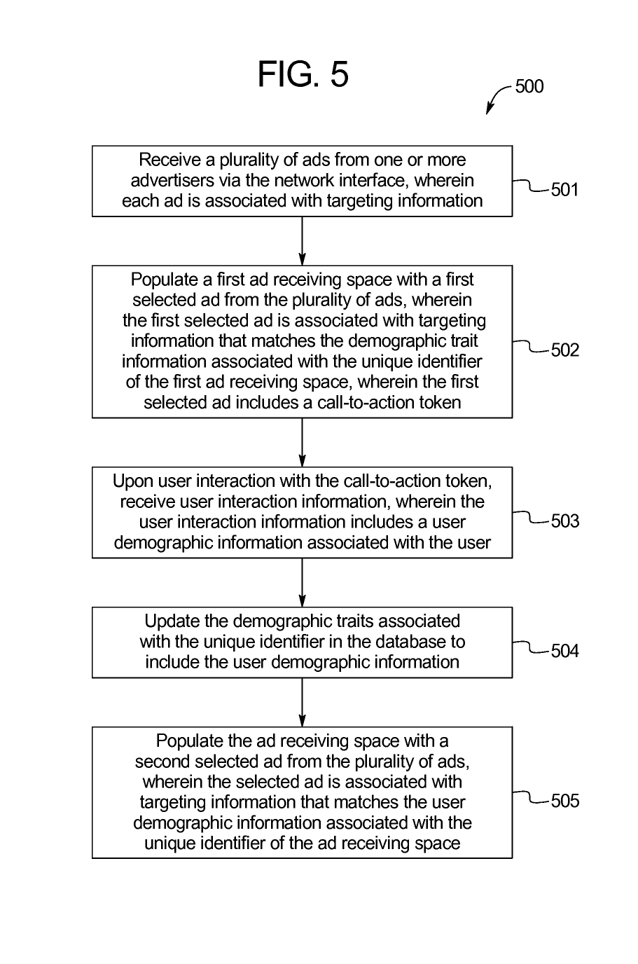

Each ad 22 may include a call-to-action 24 (FIG. 3A) to encourage the consumer 40 to respond to the ad 22 by interacting with an interaction point 50 in a manner that can be tracked by the direct marketing system 10. For example, the interaction point 50 may be a website of an advertiser 20 where the consumer 40 may purchase an advertised good. To access the website, the ad 22 may include a call-to-action token 305 such as a QR code 324 (FIG. 3A). The QR code 324 may, in turn, include identifying information 420 (FIG. 5) associated with the unique identifier 35, that permits the direct marketing system 10 to determine the cart 30 that the consumer 40 encountered to discover the call-to-action 24. For example, a consumer 40 may scan the QR code 324 with her mobile device. The mobile device may then decode the QR code 324 to extract a URL 322 that references the interaction point 50. The identifying information 420 may be a substring of the URL 322 that references the unique identifier 35, for example, if the unique identifier 35 is “5324” and the interaction point 50 is “bluepop.com,” the URL 322 may be “bluepop.com/5324”.

The interaction point 50 may communicate a user interaction information 55 of the response back to the direct marketing system 10. The user interaction information 55 may include the identifying information 420 along with information about the nature of the consumer response, such as user demographic information 430. The system 10 may then update the profile 19 to add the user interaction information 55 into a response history 450. Additionally, the system 10 may add to the profile 19 new demographic trait information 28 derived from the user interaction information 55. Periodically, user interaction information 55 of various responses may be used to derive one or more response metrics 460 (FIG. 5), such as a total dollar amount of sales in response to an ad 22.

In an embodiment, the direct marketing system 10 includes a controller 12, a network interface 14, a database 18, and a memory 16. Additionally, the system 10 may include carts 30, and, in some embodiments, the interaction point 50. The direct marketing system 10 may also include a user interface 17 to permit advertisers 20 to interact with the system 10. The user interface 17 may be provided as a web site accessible via the network interface 14 over the Internet. In other embodiments, the user interface 17 may be provided as an API to permit advertisers 20 to programmatically connect the direct marketing system 10 to their own systems. Advertisers 20 may use the user interface 17 to purchase advertising space, provide demographic targeting information, and otherwise manage the display of ads via the direct marketing system 10.

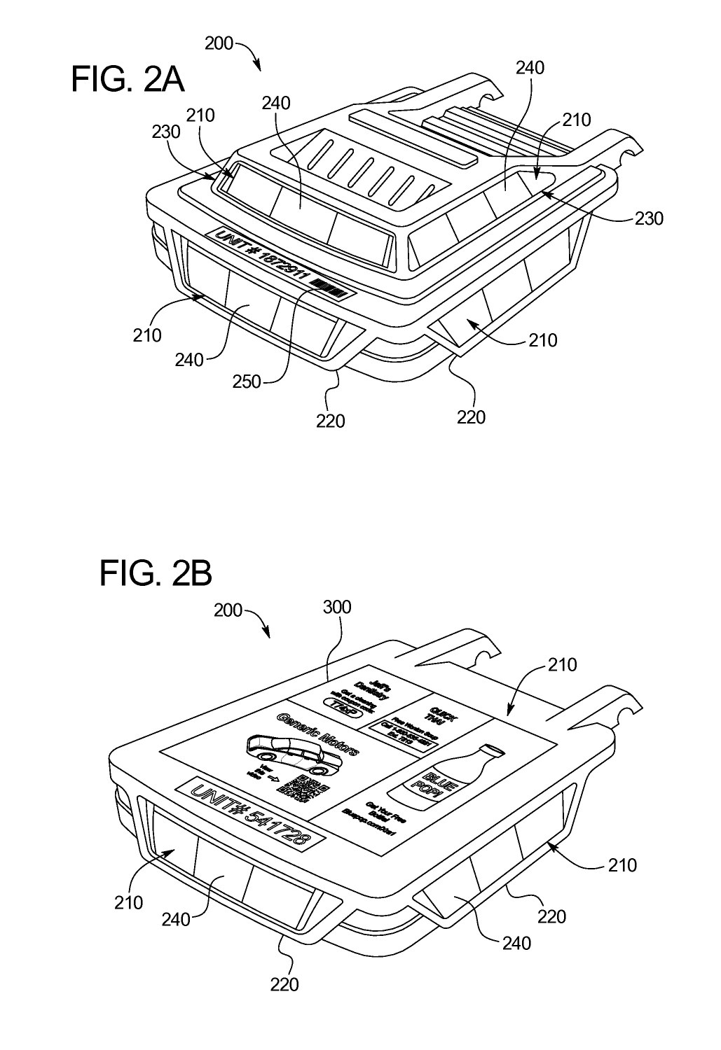

FIGS. 2A and 2B illustrate cart lids 200 for carts 30 that may be used to display ads 22. As shown in FIG. 2A, a cart lid 200 may include surfaces adapted for advertising, such as flanges 220 and an upper level 230. Both the flanges 220 and upper level 230 may include a plurality of ad receiving spaces 210. Each ad receiving space 210 may accommodate multiple ads 22. In some embodiments, the ad receiving spaces 210 may be J-channels that hold advertising placards 300 or digital display panels 240. As shown in FIG. 2B, in some embodiments, a cart lid 200 may include a large, flat ad receiving space 210 that may accommodate large advertising placards 300. For lids 200 with print ads 22 that must be manually changed, the unique identifier 35 associated with the cart 30 may be displayed on the cart lid 200 to permit a service worker to ascertain the identity of the cart 30 and to update the cart 30 with correct ads 22. The unique identifier 35 may be provided on each cart 30 as a barcode 250 that may be used to distribute ads 22 to the cart 30.

For carts with digital display panels 240, a lid processor of the cart 300 may communicate the unique identifier 35 to the direct marketing system 10 to authenticate it for receiving ads 22 intended for that specific cart 30. The direct marketing system 10 of the present disclosure may be used with any carts 30 adapted to receive advertising materials, for example, the direct marketing system 10 may be used with carts 30 including trash cart smart lids as described in U.S. Published Application No. 2014/0367292.

In order to provide cooperative advertising, ads 22 from a plurality of advertisers 20 may be included on a single cart 30. For example, as shown in FIGS. 3A and 3B, multiple ads 22 may be combined on a single advertising placard 300. One or more placards 300 may, in turn, be displayed on a single cart 30. Ads 22 may be selected for each cart 30 using the profile 19 associated with the cart 30. Accordingly, the differences between the profiles 19 for multiple carts 30 may cause variations in the ads 22 selected for the different carts 30.

Ads 22 may be provided as print or digital advertising 22. Each ad 22 may include ad graphics 320, video, audio, text, a call-to action 24, etc. Each advertiser 20 may provide one or more ads 22 to the system 10. Each ad 22 may include targeting information 26 to target ads 22 to consumers 40 with desirable demographic trait information 28. By using trash and recycling carts 30, consumer targeting may be very fine-grained and may be accomplished at approximately the household level.

Turning to FIG. 4, the profiles 19 corresponding to each cart 30 may be stored in the database 18. As shown, the profile 19 may include a unique identifier 35 that identifies the cart 30. The profile 19 may also include an address 38 to which the cart 30 is currently assigned.

The profile 19 may include demographic trait information 28 concerning the residents of the address 38, such as the number of residents at the address, their ages, gender, occupation, household income, ethnicity, etc. The profile 19 may further include demographic trait information 28 concerning persons not at the address 38. For example, carts 30 are often seen by neighbors, thus, the profile 19 may include demographic trait information 28 concerning persons at other addresses near the address 38 associated with the profile 19. It is further contemplated, that a profile 19 may be associated with demographic trait information 28 concerning a larger geographic area, such as a street, city block, neighborhood, city, state, etc.

To obtain the demographic trait information 28, the system 10 may cross-reference the address 38 with external directories, such as the Cole directory. The system 10 may additionally cross-reference addresses that are near the cart 30 with external directories.

The profile 19 may further include information derived from previous responses to ads 22 in a response history 450. For example, when the consumer 40 responds to a call-to-action 24 of an ad 22 by interacting with an interaction point 50, user interaction information 55 may be collected and associated with the profile 19. The response history 450 may include information about the ad 22, the nature of the response, identifying information 420, user demographic information 430, and other user interaction information 55.

As shown in FIG. 4, the profile 19 may include a plurality of ad slots 410 corresponding to available ad receiving spaces 210 on the cart 30. To ensure “fresh” advertising, as slots 410 may be updated periodically with new ads 22. An ad 22 may be selected for each ad slot 410 using the associated targeting information 26. As shown, ads 22 have been selected for each available ad slot 410 in the profile 19. In order to select ads 22, the targeting information 26 may be compared to the information in the profile 19, such as the demographic trait information 28.

To avoid ads 22 from competitors being placed on a single cart 30 (and potentially negatively impacting responses), each ad 22 may be associated with a product category 440, such as motor vehicles, beverages, insurers, fast food restaurants, etc. In some embodiments, product categories 440 may be hierarchical, for example, there may be a food category with a restaurants sub-category 440 that, in turn, has sub-categories 440 such as Asian food, French food, Mexican, etc. It is contemplated that an advertiser 20 may be permitted to specify the categories 440 for which competing products in those categories 440 will not be displayed on the same cart 30 as the advertiser's ads 22. For example, a Thai restaurant may choose to exclude all other restaurants in the Asian food category 440, while a five star restaurant may choose to exclude all other ads 22 in the restaurants category 440.

Targeting information 26 may be provided for each ad 22 to enable the system 10 to display ads 22 to consumers 40 desired by the advertiser 20. Targeting information 26 may be provided as target demographic trait information 415 that may be matched with the demographic trait information 28 in the profiles 19 for each cart 30. For example, as shown in FIG. 5, an ad 22 for a beverage called “Blue Pop” may be targeted to families with children. Similarly, an ad 22 for a car may be targeted to African-American men and women between the ages of 30-60.

In an embodiment, the cart 30 may record impressions 480 of a consumer interacting with the cart 30 to aid in the measurement of the reach of the ads 22. For example, the cart 30 may include a sensor to determine when the lid of the cart 30 is opened. In an embodiment, when the lid 200 is opened the cart 30 may communicate the interaction the system 10 along with the unique identifier 35, time of interaction, etc. The system 10 may then, in turn, record impression 480 for each of the ads 22 currently associated with the unique identifier 35 at the time of the lid 200 opening. The system 10 may aggregate the impressions 480 associated with each ad 22 across all carts 30 and store the impressions 480 in the profile 19. For example, the system 10 may calculate the number of impressions 480 for an ad 22 in one or more zip codes. Likewise, the system 10 may aggregate the number of impressions 480 for carts 30 near households with children. It is contemplated that to create correct impression information, the system 10 may need to filter out cart openings associated with collection by service workers. In one embodiment, the system 10 may ignore one opening of the lid 200 for each collection cycle for the cart 30. Alternatively, the cart 30 may include additional sensors to determine when an opening of the cart lid 200 should not be counted as an impression 480. For example, the cart 30 may include a tilt sensor that, when triggered during an emptying of the cart 30 causes the suppression of recording an impression 480.

FIG. 5 illustrates a method 500 that may be executed by the system 10 to carry out the functionality described herein. The method 500 includes steps that cause the controller 12 to: at step 501, receive a plurality of ads 22 from one or more advertisers 20 via the network interface 14, wherein each ad 22 is associated with targeting information 26; at step 502, populate a first ad receiving space 210 with a first selected ad 22 from the plurality of ads 22, wherein the first selected ad 22 is associated with targeting information 26 that matches the demographic trait information 28 associated with the unique identifier 35 of the first ad receiving space 210, wherein the first selected ad 210 includes a call-to-action token 305; at step 503, upon user interaction with the call-to-action token 305, receive user interaction information 55, wherein the user interaction information 55 includes a user demographic information 430 associated with the user; at step 504, update the demographic trait information 28 associated with the unique identifier 35 in the database 18 to include the user demographic information 430; and at step 505, populate the ad receiving space 210 with a second selected ad 22 from the plurality of ads 22, wherein the selected ad 22 is associated with targeting information 26 that matches the user demographic information 420 associated with the unique identifier 35 of the ad receiving space 210.

First, at step 501, the direct marketing system 10 receives a plurality of ads 22 from one or more advertisers 20 via the network interface 14, wherein each ad 22 is associated with targeting information 26. Advertisers 20 may upload ads 22 and the associated targeting information 26 using the user interface 17. The user interface 17 may be provided over the Internet via the network interface 17. Each ad 22 may include ad graphics 320, video, text, pricing, budget, calls-to-action 24, etc., and associated targeting information 26.

Next, at step 502, the direct marketing system 10 populates a first ad receiving space 210 with a first selected ad 22 from the plurality of ads 22, wherein the first selected ad 22 is associated with targeting information 26 that matches the demographic trait information 28 associated with the unique identifier 35 of the first ad receiving space 210, wherein the first selected ad 22 includes a call-to-action token 305.

As noted, targeting information 26 may be provided as target demographic trait information 28 that may be matched with the demographic trait information 28 in the profiles 19 for each cart 30. In an embodiment, each profile 19 may include the demographic trait information 28 of the people living at the address 38, along with demographic trait information 28 of surrounding homes.

For each candidate ad 22 for an ad receiving space 210, the direct marketing system 10 may calculate a weight 470 that quantifies the match between the profile 19 and the targeting information 26 of the candidate ad 22. The candidate ad 22 with the highest calculated weight 470 may be selected for the ad receiving space 210. Alternatively, in some embodiments, the weight 470 may considered along with other factors in selecting a candidate ad 22 for an ad receiving space 210.

The weight 470 may include a calculation of the match between the demographic trait information 28 of the profile 19 and the target demographic trait information 415 of the targeting information 26. In some embodiments, the demographic trait information 28 of the primary address 38 may be weighted higher. In an embodiment, the targeting information 26 of the selected ad 22 matches at least a portion of the demographic trait information 28 of the profile 19 associated with the unique identifier 35.

In another embodiment, an ad 22 may be selected when the targeting information 26 of the selected ad 22 matches the response history 450 of the profile 19. For example, the profile 19 may include purchase details 435 that include a product category 440 of a purchase. The selected ad 22 may be chosen based on targeting information 26 that targets profiles 19 including purchases in that product category 440. In another example, the profile 19 may include purchase details 435 that include a purchase value 437. The selected ad 22 may be chosen based on targeting information 26 that includes purchases of at least that value. It is contemplated that targeting information 26 may target numerous characteristics associated with previous purchases in a profile 19, such as amount of purchases, number of purchases, the demographic trait information of the purchaser, the retailer of the purchase, etc. Further, it is contemplated that the targeting information 26 may target carts 30 based on the previous response history 450 of the cart 30, for example, the targeting information 26 may target carts 30 including a profile 19 including a web site visit, coupon use, number of impression 480, etc.

Additionally, it is contemplated that the targeting information 26 may target ads 22 to geographic areas such as a city, state, zip code, block, or even particular addresses. Accordingly, in some embodiments, ads 22 may be selected based on a match between the targeting information 26 and the address 38.

To permit users to respond to an ad 22, the direct marketing system 10 may associate a call-to-action 24 with the selected ad 22, wherein the call-to-action 24 enables a consumer 40 to interact with an interaction point 50. A call to action 24 is an instruction to a consumer audience intended to provoke a measurable response, such as visiting a website, visiting a retailer, purchasing a product, calling a phone number, etc. The call-to-action 24 may include explanatory text such as “Visit our website”, “Use coupon Code”, “Scan the QR code for a video”, “Call this number for more information”, “Text 24153 to 98234”, etc., and may include a call-to-action token 305, such as a telephone number 320, a URL 322, a QR code 324, a SMS texting number and code, a barcode, a coupon number 326, an augmented reality digital tag that triggers the display of enriched content, etc. A client may also interact with the ad 22 using near field communication, for example, the cart 30 may include a NFC chip to permit the consumer 40 to interact with the ad 22 at the cart 30. For example, the ad 22 may prompt the consumer 40 to “Tap the ad to visit our website.”

The call-to-action 24 may be generated by the direct marketing system 10 or by the advertiser 20. For example, in one embodiment, the advertiser 20 may request a call-to-action token 305 from the direct marketing system 10. The direct marketing system 10 may then provide a call-to-action token 305 including, for example, a URL, QR code, or other information that may be included in the ads 22. The advertiser 20 may then incorporate the call-to-action token 305 into the ad graphics 320 before providing the ads 22 to the direct marketing system 10. In an alternative embodiment, the advertiser 20 may provide ads 22 as to the direct marketing system 10 without the call-to-action token 305. The direct marketing system 10 may then incorporate call-to-action token 305 into the ads 22 before distribution to the carts 30 for display. In yet another embodiment, the advertiser 20 may provide ads 22 with a call-to-action token 305 already incorporated into the ads 22. In such embodiments, the advertiser 20 may additionally provide information about the call-to-action token 305 to permit the system 10 to associate the call-to-action token 305 with the unique identifier 35 such that the system 10 may track consumer responses.

The call-to-action tokens 305 may be used to track responses to the ads 22. In an embodiment, the system 10 provides call-to-action tokens 305 that are each unique to a particular cart 30. The unique call-to-action tokens 305 permits the system 10 to determine the cart 30 at which the user saw the ad 22 to enable the system 10 to provide a record of a response to the advertiser 20.

Alternatively, in some embodiments, call-to-action tokens 305 may be shared across multiple unique identifiers 35. For example, a call-to-action token 305 may be shared on multiple carts 30 on a city block, neighborhood, city street, zip code, county, eLOT, or any other geographically defined area. Additionally, call-to-action tokens 305 may be shared on a single campaign, or on subsets of a campaign, such as a time period, ad type, audience type, etc.

Each call-to-action token 305 may include unique identifying information 420 to distinguish it from the other call-to-action tokens 305. The identifying information 420 may be extracted by the interaction point 50 and be communicated back to the direct marketing system 10 to confirm a response to an ad 22. The identifying information 420 may be embedded in the URL 322, QR code 324, coupon code 326, etc., of the call-to-action 24.

To populate the ads 22 in the ad receiving spaces 210, the ads 22 selected for each cart 30 may be assembled for distribution to the carts 30. For example, the ad graphics 320 of the ads 22 may be assembled into combined graphics for printing onto advertising placards 300. The combined graphics may be transmitted to a printer or to a cart management organization 32, such as a municipality, in a “use-sequence.” That is, the direct marketing system 10 may interact with carrier route presort software to place bundles of placards in “mail carrier sequence.” The ads 22 for each cart 30 may be provided with the unique identifier 35 and/or the address 38 to permit appropriate routing of the advertising placards 300. The ads 22 may be printed on UV resistant material, such as UV resistant polystyrene, using UV resistant ink to create a durable advertising placard 300. Advertising placards 300 may be trimmed to fit snugly in J-channels of the carts 30 and may be distributed by servicers of the cart management organization 32. Periodically, such as every ninety days, the cart management organization 32 may remove the installed ads 22 and replace them with a new set of selected ads 22.

Where digital advertising is available on carts 30, the ads 22 may be directly transmitted to the carts 30. To receive ads 22, each cart 30 may authenticate to the system 10 using the unique identifier 35. The direct marketing system 10 may also receive an augmented reality digital tag, where available for use with the cart 30. The ads 22 may then be displayed on digital screens within the cart 30.

Next, at step 503, the direct marketing system 10, upon user interaction with the call-to-action token 305, the direct marketing system 10 receives user interaction information 55, wherein the user interaction information 55 includes a user demographic information 430 associated with the consumer 40.

The consumer 40 may use the call-to-action token 305 to interact with an interaction point 50. The interaction point 50 may be a phone number, website, physical location, etc. that a consumer 40 may interact with in response to call-to-action 24. For example, the consumer 40 may visit a website interaction point 50 using a URL 322 that is associated with a unique identifier 35. The website, as the interaction point 50, captures identifying information 420 that identifies the cart 30 when the consumer 40 encountered the call-to-action 24. The interaction point 50 may be a part of the direct marketing system 10, or may be third-party computer system in communication with the direct marketing system 10.

The interaction point 50 may additionally capture response information regarding the consumer's actions. For example, if the consumer 40 purchases a product at the interaction point 50, the purchase details 435, user demographic information 430, and/or any other data about the response may be captured by the interaction point 50. The interaction point 50 may send user interaction information 55 of the consumer response to the controller 12 along with the identifying information 420 of the call-to-action token 305. The user interaction information 55 may include information captured during the response interaction, such as, a sale, the time of sale, the name of the consumer, the address of the consumer, demographic information of the consumer, etc. In an embodiment, the user interaction information 55 identifies the cart 30 that the led to the response from the consumer 40 at the interaction point 50. For example, using the identifying information 420, the system 10 may determine the unique identifier 35 associated with the call-to-action token 305 including the identifying data 420, and include the response information in the response history 450 of the profile 19 associated with the unique identifier 35.

Further, at step 504, the direct marketing system 10 updates the demographic trait information 28 associated with the unique identifier 35 in the database 18 to include the user demographic information 430. User demographic information 430 of a consumer may be captured during the consumer's interaction with the interaction point 50. For example, the demographic trait information 28 may be created based on a business profile of the consumer 40 and transmitted to the system 10. The demographic trait information 28 may be stored as user demographic information 430 stored in the response history 450. The system 10 may use user demographic information 430 when selecting ads 22 in step 502.

Even further, at step 505, the direct marketing system 10 populates a second ad receiving space 210 with a second selected ad 22 from the plurality of ads 22, wherein the second selected ad 22 is associated with targeting information 26 that matches the user demographic information 420 associated with the unique identifier 35 of the second ad receiving space 210.

Additionally, the direct marketing system 10 may derive response metrics 460 from the user interaction information 55 of the response interaction. Response metrics 460 may be derived from the user interaction information 55 received by the system 10 for an ad 22 or a plurality of ads 22. As some examples, response metrics 460 may include the total number of responses for an ad, the total number of responses for an ad in geographic area, the total number of responses for an ad for a demographic category, a ratio of the number of responses and the number of ad impressions, total sales from converted consumers, a number of impressions of a web resource, such as a video, the number of augmented reality interactions, the number of phone call interactions, the number of coupons redeemed, etc.

Response metrics 460 may be provided to the advertisers 20 via the user interface 17 or network interface 14 of the system 10. In some embodiments, the marketing system 10 may be compensated based on a response statistic, such as the number of responses, the total dollar value of responses, the nature of the response, etc.

It is understood that carts 30 may be replaced over time, and the cart 30 at a particular address 38 may change. In some embodiments, the unique identifier 35 may be cart-specific, thus, if the cart 30 at an address 38 is changed, the unique identifier 35 for the profile 19 associated with that address 38 may be updated. The system 10 may provide a mechanism for cart management organizations 32 to appropriately update the unique identifier 35 for an address 38.

Aspects of the systems and methods described herein are controlled by one or more controllers 12. The one or more controllers 12 may be adapted run a variety of application programs, access and store data, including accessing and storing data in associated databases 18, and enable one or more interactions via the device 10. Typically, the one or more controllers 12 are implemented by one or more programmable data processing devices. The hardware elements, operating systems, and programming languages of such devices are conventional in nature, and it is presumed that those skilled in the art are adequately familiar therewith.

For example, the one or more controllers 12 may be a PC based implementation of a central control processing system utilizing a central processing unit (CPU), memories 16 and an interconnect bus. The CPU may contain a single microprocessor, or it may contain a plurality of microprocessors for configuring the CPU as a multi-processor system. The memories 16 include a main memory 16, such as a dynamic random access memory (DRAM) and cache, as well as a read only memory 16, such as a PROM, EPROM, FLASH-EPROM, or the like. The system may also include any form of volatile or non-volatile memory 16. In operation, the main memory 16 stores at least portions of instructions for execution by the CPU and data for processing in accord with the executed instructions.

The one or more controllers 12 may also include one or more input/output interfaces for communications with one or more processing systems. The one or more such interfaces may include a network interface 14 to enable communications via a network, e.g., to enable sending and receiving instructions electronically. The communication links may be wired or wireless.

The one or more controllers 12 may further include appropriate input/output ports for interconnection with one or more output displays (e.g., monitors, printers, touchscreen, motion-sensing input device, etc.) and one or more input mechanisms (e.g., keyboard, mouse, voice, touch, bioelectric devices, magnetic reader, RFID reader, barcode reader, touchscreen, motion-sensing input device, etc.) serving as one or more user interfaces 17 for the controller 12. For example, the one or more controllers 12 may include a graphics subsystem to drive the output display. The links of the peripherals to the system may be wired connections or use wireless communications.

Although summarized above as a PC-type implementation, those skilled in the art will recognize that the one or more controllers 12 also encompasses systems such as host computers, servers, workstations, network terminals, and the like. Further one or more controllers may be embodied in a mobile device, such as a mobile electronic device, like a smartphone or tablet computer. In fact, the use of the term controller 12 is intended to represent a broad category of components that are well known in the art.

Hence aspects of the systems and methods provided herein encompass hardware and software for controlling the relevant functions. Software may take the form of code or executable instructions for causing a controller or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A marketing system comprising:
a network interface;
an ad receiving item including a first ad receiving space, wherein the receiving item is associated with a unique identifier;
a database including a plurality of unique identifiers, wherein each unique identifier is associated with an address and a demographic trait information;
a controller in communication with the network interface and the database; and
a memory in communication with the controller, the memory including instructions, that when executed by the controller, cause the controller to:
a) receive a plurality of ads from an advertiser via the network interface, wherein each received ad is associated with a targeting information,
b) populate the first ad receiving space with a first selected ad from the plurality of ads, wherein the first selected ad is associated with targeting information that matches the demographic trait information associated with the unique identifier of the first ad receiving space, wherein the first selected ad includes a call-to-action token;
c) upon user interaction with the call-to-action token, receive user interaction information, wherein the user interaction information includes a user demographic information associated with the user;
d) update the demographic trait information associated with the unique identifier in the database to include the user demographic information; and
e) populate a second ad receiving space with a second selected ad from the plurality of ads, wherein the second selected ad is associated with the targeting information that matches the user demographic information associated with the unique identifier of the second ad receiving space.

2. The marketing system of claim 1, wherein each ad receiving item is configured to receive a plurality of selected ads.

3. The marketing system of claim 1, wherein the ad receiving item is a cart lid.

4. The marketing system of claim 1, wherein the demographic trait information includes a demographic trait of a person other than those living at the address.

5. The marketing system of claim 4, wherein the demographic trait information includes a demographic trait of a person who previously made a purchase using a call-to-action token associated with the unique identifier.

6. The marketing system of claim 4, wherein the demographic trait information includes a demographic trait of a person living at addresses in proximity to the address.

7. The marketing system of claim 1, wherein the demographic trait information includes a product category of a purchase, wherein the second selected ad is associated with a product, wherein the product is associated with the product category.

8. The marketing system of claim 1, wherein each ad receiving item includes a plurality ad receiving spaces, wherein the controller is configured to populate each of the plurality of ad receiving spaces with a plurality of selected ads, wherein each call-to-action token associated with each selected ad is different.

9. The marketing system of claim 1, wherein the user interaction includes a purchase by the user.

10. The marketing system of claim 1, wherein the user interaction includes a coupon use by the user.

11. The marketing system of claim 1, wherein the user interaction includes a phone call by the user.

12. The marketing system of claim 1, wherein the call-to-action token is a URL.

13. The marketing system of claim 1, wherein the call-to-action token is a telephone number.

14. The marketing system of claim 1, wherein the call-to-action token is a coupon code.

15. The marketing system of claim 1, wherein the call-to-action token is an augmented reality beacon.

16. The marketing system of claim 1, wherein the memory includes further instructions to:
derive a response metric from the user interaction information of the interaction.

17. A method for marketing, comprising the steps of
a) providing a cart, wherein the cart includes an ad receiving space, wherein the ad receiving space is associated with a unique identifier, wherein each unique identifier is associated with an address and a demographic trait information;
b) receiving a plurality of ads from an advertiser, wherein each received ad is associated with a targeting information,
d) selecting a selected ad from the plurality of ads, wherein the selected ad is associated with targeting information that matches the demographic trait information associated with the unique identifier of the cart;
e) printing the selected ad to form an advertising placard;
f) installing the advertising placard in the ad receiving space of the cart;
g) upon user interaction with a call-to-action token associated with the selected ad, receiving user interaction information, wherein the user interaction information includes a user demographic information associated with the user;
h) updating the demographic trait information associated with the unique identifier in the database to include the user demographic information;
d) selecting a second selected ad from the plurality of ads, wherein the selected ad is associated with targeting information that matches the demographic trait information associated with the unique identifier of the cart;
e) printing the second selected ad to form an advertising placard; and
f) installing the second advertising placard in the ad receiving space of the cart.
